(19) United States
(12) Patent Application Publication
(10) Pub. No.: US 2007/0046067 A1
(43) Pub. Date: Mar. 1, 2007

(54) Rollers for aerodynamic impact

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/393,639

(22) Filed: Mar. 30, 2006

Related U.S. Application Data
(60) Provisional application No. 60/666,754, filed on Mar. 30, 2005.

(51) Int. Cl. B62D 25/00

(52) U.S. Cl. 296/181.6

(57) ABSTRACT

An aerodynamic aid for vehicles, including automobiles, trucks, trains, airplanes and motorcycles. A cylindrical roller is rotatably mounted in the path of airflow over the vehicle's body. When the air begins to flow, the roller rotates and causes air resistance of the vehicle to change. The roller can increase or decrease air flow through spaces where there is negative pressure.

### CROSS-REFERENCES TO RELATED APPLICATIONS

This application claims the benefit of U.S. Provisional Application No. 60/666,754 filed Mar. 30, 2005.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to aerodynamic devices for vehicles, such as automobiles, trucks, airplanes, jets, and any other vehicles that move through air.

2. Description of the Related Art

It is known in the field of aerodynamics that “dead spaces” exist behind vehicles that move through air, and such dead spaces contain drag-increasing negative air pressures behind them. Existing devices, such as wings, are used to drive air into dead spaces in order to reduce the drag on the vehicle. As the vehicle moves through the air, the wing directs air into the dead spaces to reduce this negative pressure.

Wings and other aerodynamic devices are typically stationary, inasmuch as they do not move as the vehicle is moving. Some devices can move as the vehicle is moving, but such devices only move due to their attachment to a part of the vehicle that move, such as suspension components. Thus, as the suspension components move relative to the vehicle body, the aerodynamic device moves. However, this movement is very limited, and is not controlled by wind speed, but suspension movement or some other factor not related to the aerodynamic impact that the device is intended to affect. Alternative devices include wings that raise and lower according to speed of the vehicle, so that as the vehicle's speed increases, the wing rises to produce more downwardly-directed force to stabilize the vehicle.

Wings and other aerodynamic devices have disadvantages. Therefore, the need exists for devices that reduce the negative air pressure in dead spaces and otherwise affect the aerodynamic effects, such as by increasing drag, without the attendant disadvantages of wings.

### BRIEF SUMMARY OF THE INVENTION

The invention is an aerodynamic apparatus mounted to a vehicle having a vehicle body over which air flow passes during motion of the vehicle. The apparatus comprises a roller rotatably mounted about its axis to the vehicle body and having a radially outwardly facing surface. The radially outwardly facing surface of the roller is disposed near an edge of the vehicle body over which the air flow passes during motion of the vehicle. This permits air that flows over the roller to tend to rotate the roller. Upon rotation, the roller affects the aerodynamic properties of the vehicle.

### BRIEF DESCRIPTION OF THE SEVERAL VIEWS OF THE DRAWINGS

FIG. 1 is a side schematic view illustrating a conventional box truck on which an embodiment of the invention is mounted.

FIG. 2 is a view in perspective illustrating a close-up view of the invention on the FIG. 1 truck.

FIG. 3 is a view in perspective illustrating the roller of the FIG. 1 embodiment.

FIG. 4 is a view in perspective illustrating an alternative embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

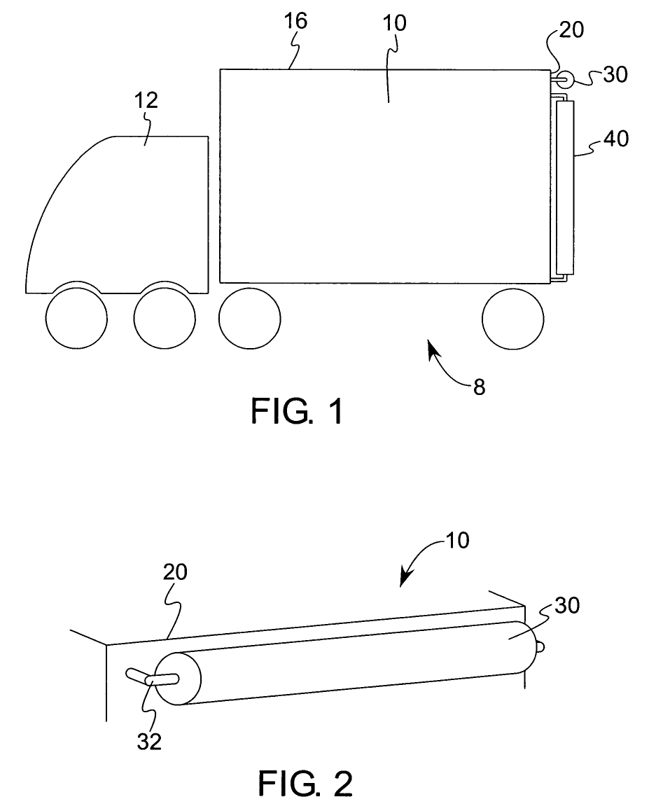

The truck 8 in FIG. 1 has a cargo box 10 mounted on a frame, and a cab 12, as is well known. As the truck moves through the air, it forces the air beside it, above it and below it. That air is pressurized locally due to its displacement by the truck body, and as the truck moves through the air, the air passes back around the rear thereof. However, because the rear of the conventional truck box 10 has an abrupt transition, the air passes over the back edge 20 of the box 10, rather than conforming exactly to the trailing surface of the box 10, and would create a low pressure area just below the back edge 20 if it were not for the invention, which will now be described.

A roller 30 is rotatably mounted to the box 10 with the axis of the roller 30 substantially parallel to the back edge 20. The roller 30 extends almost the entire width of the box 10, although the length of the structure can vary, as discussed below. The roller 30 is preferably a circular cylinder made of a lightweight material, such as hollow aluminum, plastic, composite (e.g., fiberglass or carbon fiber) or any other material that will suffice, as will be understood by a person having ordinary skill in the art from the description herein.

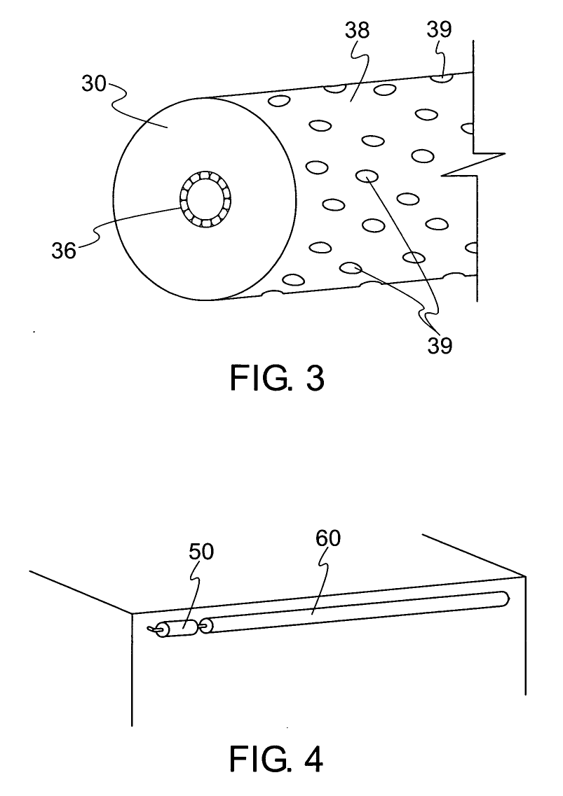

The roller 30 is mounted to the box 10 by a pair of mounting legs 32 and 34 at opposite ends of the roller 30 (mount 34 is not shown). The legs 32 and 34 are substantial mirror images of one another, and function to mount the roller 30 securely to the body to which it is attached. For example, the legs 32 and 34 can be made of lightweight aluminum, and can mount with flanges at the end seating against the box 10. The ends of the legs that attach to the roller 30 preferably insert into a low-friction ball-bearing assembly 36, shown in FIG. 3. The ball-bearing assembly is conventional and can be press-fit into an aperture at each end of the roller 30, preferably aligned coaxially with the axis of the roller 30. Thus, the roller 30 is mounted to the box 10 so that it can rotate freely about its axis, but will not detach from the vehicle until deliberately removed, such as for maintenance or replacement.

The roller 30 is mounted with its radially outwardly facing surface 38 to near a plane that contains the roof 16 of the box 10. The surface 38 can be aligned precisely along the plane, thereby aligning the plane along a tangent of the surface 38, or it can be raised above it or below it. In all cases, however, the surface 38 is aligned along the path of air that flows over the vehicle body, such as the roof 16, so that at least some of the molecules of air moving over the body impinge more upon one half of the surface 38 than the opposite half. This impingement of the molecules on the surface 38 causes the roller 30 to rotate about its axis. The volume of air molecules that impinge upon the surface 38, the speed of the air and other factors, which will become apparent to the person having ordinary skill from this description, will affect the acceleration of and the velocity of the roller 30.

As the roller 30 rotates, it attains a desired speed, which is preferably equal to, greater than or less than, the speed of the air passing over the vehicle body just upstream of the roller 30. When the surface 38 rotates substantially the same speed as the air, the resistance that the rotating surface 38 presents to air molecules passing over the box 10 is less than the air molecules would encounter if there was no roller. This is due to the fact that the surface 38 is moving faster than a stationary object. Additionally, the curvature of the roller 30 more gradually directs air around the box 10. Finally, and very importantly, because the roller 30 is rotating, its outer surface 38 tends to force air behind the box 10 where negative pressure otherwise exists in conventional trucks of the same shape as the truck 8 (without the invention attached thereto).

In a preferred embodiment, the roller 30 has dimples 39 or concave depressions of any other kind, including elongated concave depressions, such as slots, formed in the curved surface 38 in order to increase the friction between the surface 38 and air molecules passing over the surface 38. The dimples 39 thus function in the manner of dimples on the outer surface of a conventional golf ball. As another alternative, the roller could have convex bumps that protrude out of the surface of the roller.

In addition to the roller 30 on the top edge of the box 10, the roller 40 is preferably mounted to the side edge of the box 10. The roller 40 is mounted in a manner similar to the roller 30, but at the side edge of the box 10, rather than the top edge 20. Other rollers can be mounted on the other edges of the box 10, including the bottom and the leading edges, as will be apparent to the person having ordinary skill in the art.

Thus, the invention is a roller mounted on bearings so that it can rotate very freely. The goal of the invention is to improve the aerodynamic effects of the object moving through the air. In order to achieve that goal, a plurality of such rollers can be strategically mounted on any vehicle trying to move through the air efficiently, including, but not limited to, an automobile, truck, tractor-trailer, train, motorcycle, bicycle or airplane. Rollers are positioned near edges of the vehicles' bodies around which air rushes when the vehicle is in motion, and more of one part of the rollers are exposed to air rushing over the edge of the body than the other. The air causes the rollers to rotate about their axes as more air passes over one edge of the roller than the other.

The rollers force air into “dead spaces” behind vehicles that otherwise contain drag-increasing negative air pressures. When left to rotate freely, the rollers, as dictated by the laws of physics, tend to rotate at the most efficient speed to reduce drag by filling the negative pressure zones with air, thus reducing the drag on the vehicle. The rollers thus effectively alter the aerodynamic “shape” of the object they are attached to. The rollers adjust their rotating speed to the optimum level to reduce wind resistance. The spinning rollers alter the airflow and improve aerodynamic efficiency.

The rotation of the rollers can also be controlled to alter their aerodynamic effects to suit certain situations, such as by attaching a motor 50, as in FIG. 4, or brakes to the rollers. The driveshaft of the motor 50 is mounted to the roller 60 either by a rigid connection, or by a “coasting” device, similar to that in a bicycle hub, that prevents the motor 50 from resisting movement of the roller 60 in one direction when such resistance is not desired, but provides a drive link to the roller 60 in the other direction.

The rollers can thus be artificially slowed to generate drag, thereby slowing a vehicle, or the rollers' speeds can be increased beyond that due to the flow of air in order to generate less drag or more lift, such as for a wing, thereby utilizing an energy source to induce certain effects. Of course, with multiple rollers, different rollers can be affected differently in order to best accomplish the desired result, as in an automobile in which the brakes, accelerator and the rollers of the invention are controlled by a vehicle's stability control system.

The roller need not be a circular cylinder. The roller could be octagonal or any other polygonal cylinder. Alternatively, the roller could have a larger diameter in the middle than at the ends, or could be larger at one end than the opposite end, such as with a cone or other tapered shape, as will become apparent to a person having ordinary skill in the art. This allows the roller to be tailored to the particular structure to which it is mounted.

Still further, the roller can be made up of multiple disks or rotatably-mounted polygons “stacked” together with aligned axes in order to affect airflow around a vehicle. This would permit rotation of one disk relative to another.

While certain preferred embodiments of the present invention have been disclosed in detail, it is to be understood that various modifications may be adopted without departing from the spirit of the invention or scope of the following claims.

1. An aerodynamic apparatus mounted to a vehicle having a vehicle body over which air flow passes during motion of the vehicle, the apparatus comprising:
(a) a roller rotatably mounted about its axis to the vehicle body;
(b) a radially outwardly facing surface of the roller disposed near an edge of the vehicle body over which the air flow passes during motion of the vehicle.

2. The apparatus in accordance with claim 1, further comprising a plurality of concave depressions formed in the radially outwardly facing surface.

3. The apparatus in accordance with claim 2, wherein the concave depressions comprise dimples.

4. The apparatus in accordance with claim 2, wherein the concave depressions comprise elongated slots.

5. The apparatus in accordance with claim 1, wherein the roller is rotatably mounted on bearings that permit substantially free rotation of the roller thereabout.

6. The apparatus in accordance with claim 1, further comprising means for driving the roller about its axis.

7. The apparatus in accordance with claim 6, further comprising means for braking the roller to decrease its rotational speed.

8. The apparatus in accordance with claim 1, further comprising a plurality of rollers rotatably mounted about their axes to the vehicle body, each roller having a radially outwardly facing surface disposed near an edge of the vehicle body over which the air flow passes during motion of the vehicle.

9. The apparatus in accordance with claim 1, wherein the roller is a circular cylinder.
